(19) United States
(12) Patent Application Publication
(10) Pub. No.: US 2014/0114736 A1
(43) Pub. Date: Apr. 24, 2014

(54) CONSUMER VENDING SYSTEM AND METHOD

(71) Applicant: VendMark, LLC, South Barrington, IL (US)

(72) Inventors: William W. Kennedy, Barrington Hills, IL (US); Richard Bates, Sycamore, IL (US); Robert M. McAuliff, Bartlett, IL (US); William Daniel Kennedy, Fountain Hills, AZ (US); Peter Mueller, Gilbert, AZ (US); Charles Zimnicki, Lake Zurich, IL (US)

(21) Appl. No.: 14/057,455

(22) Filed: Oct. 18, 2013

Related U.S. Application Data
(60) Provisional application No. 61/716,170, filed on Oct. 19, 2012.

(51) Int. Cl. G06Q 30/02

(52) U.S. Cl. CPC G06Q 30/0224
USPC 705/14.25; 705/14.1; 705/14.4; 705/14.38

(57) ABSTRACT

A coupon dispensing module for use in conjunction with a vending machine includes a selection mechanism adapted to interrogate a database to determine whether a desired coupon corresponds to the desired product, a printing mechanism adapted to print the desired coupon, a dispensing mechanism for dispensing the desired coupon upon the receipt of an actuating signal, and a control circuit coupled to the vending machine, the control circuit operating to interrogate the database to determine whether the desired coupon is available, operate the printing mechanism based on requirements of the desired coupon, and provide the actuating signal to the dispensing mechanism.

### FIELD OF THE DISCLOSURE

This disclosure relates generally to vending machine systems and, more particularly, to a system and method for enhancing new and existing vending systems.

### BACKGROUND

The vending market in the United States is estimated to be in the range of billions of dollars annually. In a typical day, millions of purchases can be made. To accommodate this market, vending machines of various types are known. Such vending machines typically operate to dispense items such as snacks, beverages, consumer products and the like to customers in an automated fashion upon receipt by the machine of currency or credit from a customer. Such machines often include a dispensing mechanism that operates to make available a desired product to a customer upon the insertion of money or credit by a purchaser. In one example, the product is made available to the customer by releasing the product, such that it falls into an appropriate compartment at the bottom of the machine. In other examples, the product is dispensed through an unlocking of a door, a drawer, or the like or through a combination of various mechanical arrangements.

Methods for sophisticated targeted marketing to consumers and the like are also known. For example, Internet-based tracking technologies are known that are capable of monitoring the “click” activity of users who navigate web sites in order to make purchases of merchandise, or simply to browse such sites. Also, methodologies for tracking the activity of “smart-phone” users and the like are known in which advertisements are provided to consumers based upon their location, social groups to which they belong, and other activities that can be monitored.

### BRIEF SUMMARY OF THE DISCLOSURE

The present disclosure comprises, in one aspect, a coupon dispensing module that may be used in conjunction with a snack, food and beverage (SFB) consumer vending machine that is operable to generate a vend signal when a purchaser selects a desired product. Although a SFB is described in the embodiments presented herein, it is contemplated that the systems and methods described herein can be used in any type of automated vending machine. Examples of automated vending systems, in addition to those described and shown herein, which may incorporate the inventive systems and methods, include vending machines for non-edible articles such as electronics and other consumer goods, automated kiosks for providing services, such as check-in terminals for airports and others, and automated machines for vending tickets or rental movies. Moreover, the described systems and methods may further accept coupons as at least partial payment or discount for goods and services sold in addition to dispensing them.

In one disclosed embodiment, the coupon dispensing module includes a vending mechanism adapted to create, on demand, a coupon or coupons of any of a plurality of configurations. In addition, the vending mechanism is adapted to print a desired one of the plurality of configurations upon the receipt of an actuating signal. The coupon dispensing module also includes a control circuit that is coupled to the vending machine. Upon receipt of the vend signal from the vending machine, the control circuit selects one of the plurality of configurations and commands the dispensing mechanism to create the desired one of the plurality of configurations and to dispense same. In this way, a coupon may be dispensed to a purchaser based upon pre-loaded advertising campaigns that may relate to the product purchased. Additionally, the machine may be configured to accept coupons provided by other machines or online coupon companies that can be accepted within the same or a different network of machines, or coupons provided to the consumers via other means, for example, on product packaging or printed mailings and other printed media.

In another aspect, a method for dispensing a coupon relating to the consumer purchase of a desired product from a vending machine uses a dispensing module that is configured to receive a vend signal from the vending machine associated with the selection of a desired product by a purchaser. The method then selects one of a plurality of coupons based upon the product selected. The method next creates the desired coupon or coupons by printing the same, and dispenses the coupon or coupons to the purchaser of the product. Accordingly, a coupon is dispensed to the purchaser based upon an advertising campaign that is associated with the product purchased.

In yet another aspect, this disclosure relates to configuring and operating a media advertising and coupon trafficking control center that is connected via a network to a plurality of vending machines in accordance with the disclosure. Such control center is generally referred to herein as a “media center,” which term is intended to encompass all hardware, software and/or other functional aspects of the systems described relative to the coordination of advertising campaigns involving coupons presented to customers transacting with vending machines. Specifically, one or more vending machines may be configured to include a coupon dispensing module that is connected via a two-way or a one-way communication network to the media center. The media center is configured to send messages and/or receive messages from the coupon dispensing modules. In one embodiment, this arrangement enables trafficking and monitoring of advertising campaigns and couponing offers on a local, regional, national and/or international level to thereby allow advertisers and advertising campaign partners to geographically target marketing programs in territories throughout the world. In addition, the media center may be used to monitor, infer and/or capture consumer purchasing trends and purchasing intelligence, thereby obtaining information concerning demographics, psychographics, and behavioral targeting with respect to certain locations or regions. Such a network may be implemented on any one or more of a local, regional, national and international level.

Aspects of the disclosure describe a coupon dispensing module for use in conjunction with a vending machine. The dispensing module is operable to generate a vend signal when a purchaser selects a desired product. The dispensing module includes a selection mechanism adapted to interrogate a database to determine whether a desired coupon corresponds to the desired product, a printing mechanism adapted to print the desired coupon, and a dispensing mechanism for dispensing the desired coupon upon receipt of an actuating signal. A control circuit is coupled to the vending machine and operates to interrogate the database to determine whether the desired coupon is available, operate the printing mechanism based on requirements of the desired coupon, and provide the actuating signal to the dispensing mechanism.

In one embodiment, a method for operating a vending machine is described. The method includes monitoring a vending system of the machine to determine whether a transaction has been made. When a transaction has been made with a customer, the particular product dispensed is determined and associated with a selected coupon, which coupon is selected from a plurality of coupons. The selected coupon is printed and dispensed or otherwise delivered to the customer within a short period before or after the particular product is dispensed from the vending machine.

In another embodiment, a method for controlling and monitoring a plurality of vending machines associated with a communications network by use of a media center is described. The method includes defining a plurality of correspondences between products and coupons with respect to, by way of example, a geographical area, creating a coupon database containing the correspondences, and maintaining the coupon database in non-transient computer readable media. The coupon database is transmitted to at least one vending machine. Information from the at least one vending machine relative to purchases made at the at least one vending machine is received, analyzed and stored. The coupon database is updated, at least partially, based on the information received from the at least one vending machine to create an updated coupon database, which is sent to the vending machine.

### BRIEF DESCRIPTION OF THE SEVERAL VIEWS OF THE DRAWING(S)

FIG. 1 is a block diagram of an integrated marketing and merchandising network that may be employed in accordance with an embodiment of the disclosure.

FIG. 2 is a block diagram representation of a vending machine that includes a coupon dispensing module in accordance with another aspect of the disclosure.

FIG. 3 is a block diagram representation of the coupon dispensing module of FIG. 2, shown in more detail.

FIG. 4 is an electrical block diagram representation of the vending machine and coupon dispensing module in accordance with the disclosure.

FIG. 5 is another a block diagram representation of a vending machine in accordance with the disclosure.

FIG. 6 is a simplified perspective illustration of an exemplary installation on the face of a beverage vending machine.

FIG. 7 is a simplified perspective illustration of an exemplary installation provided on the face of a snack and food vending machine.

FIGS. 8 and 9 are block diagrams of vending machines in accordance with the disclosure.

FIGS. 10 and 11 are state-flow diagrams in accordance with the disclosure.

FIG. 12 is a block diagram for a media center implementation in accordance with the disclosure.

FIGS. 13-17 are sample user interfaces for a computer-executable application in accordance with the disclosure.

### DETAILED DESCRIPTION OF THE INVENTION

Generally, this disclosure relates to an architecture and system that can be used in the consumer vending machine industry. In one aspect, a coupon dispensing module is coupled to a vending machine and is configured to communicate via a network such as the Internet to a media center disposed for managing and trafficking advertising campaigns and couponing offers. In another aspect, this disclosure relates to a method that includes using various components, such as phases, tasks, methods, techniques and tools, all related to uniting and providing marketing opportunities for the vending industry factions/stakeholders such as operators, food and beverage companies, technology providers, media networks, manufacturers, and the like, to enable marketing opportunities for vendors and suppliers.

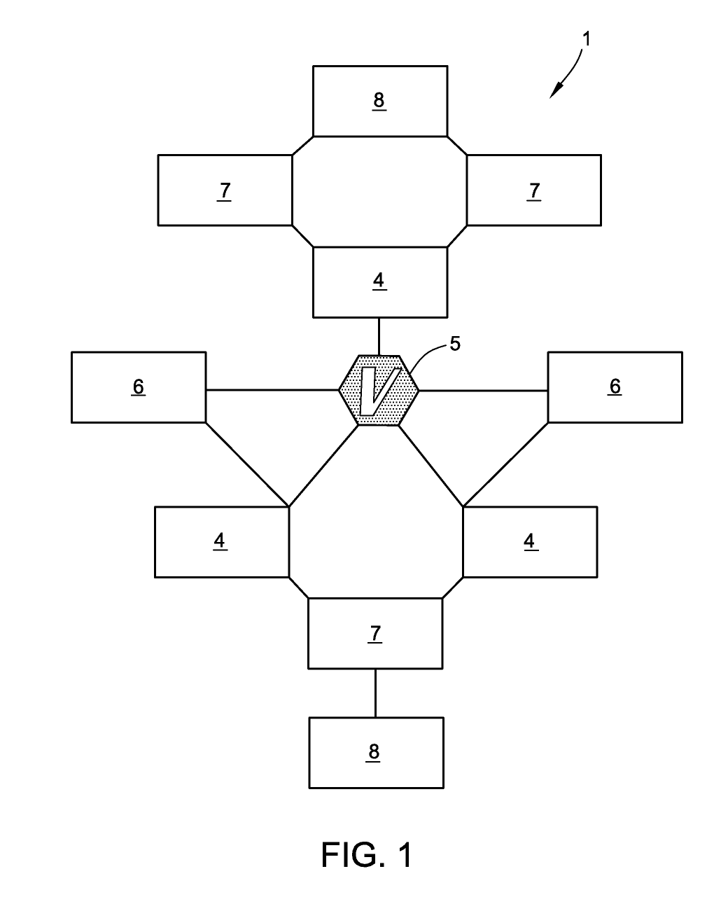

FIG. 1 shows a block diagram representation of an integrated marketing and merchandising network 1, suitable for use in the vending machine industry in accordance with the disclosure. In one embodiment, an integrated network of computers, vending machines, and a virtually controlled command station is configured to interconnect various machines in various locations. In the illustrated embodiment, the virtually controlled command station is embodied as a media center 5, which is connected to a vending machine operator computer 4 and to advertiser or client computers 6 (two shown). The media center 5 is a central repository for coupon offers and/or advertising campaigns, and their effective dates at various levels, such as local, regional, national, and international levels. The two client computers 6 may belong to the same or different companies, marketing firms, manufacturers and the like wishing to conduct marketing programs for their, brands, products and/or services. Information, such as advertising campaigns, strategic partnerships, discounts and coupon information may be provided to the media center 5 from the clients 6 for dissemination into the marketing channel of the network 1. When information is received at the media center 5, the information is processed and disseminated to the vending machine operator computer 4. From there, the information is distributed to vending machine controllers 7, through which coupons and other marketing materials may be delivered to the consumers 8. In one illustrated embodiment, the vending machine operator computer 4 may receive information both from the media center 5, as well as directly from the client systems 6. Information received from the client systems may be in the form of updates to current advertising campaigns and the like. Feedback and redemption information can be provided from the machines back to the media center 5, and from there, to the various clients 6.

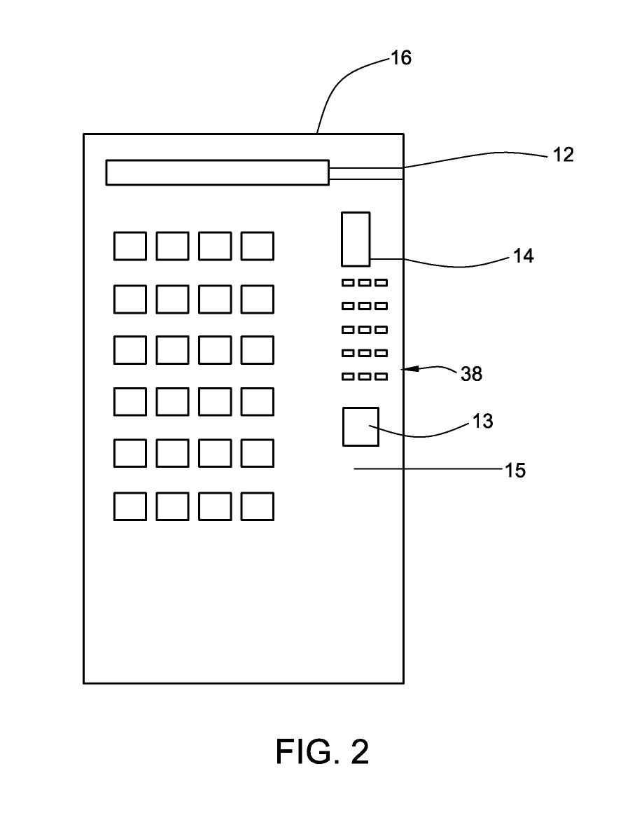

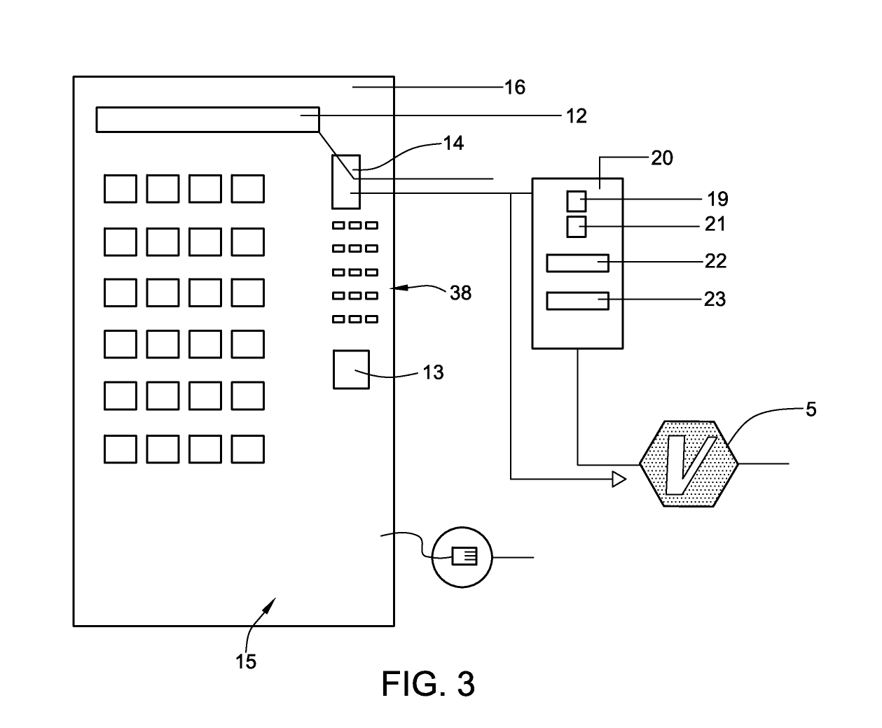

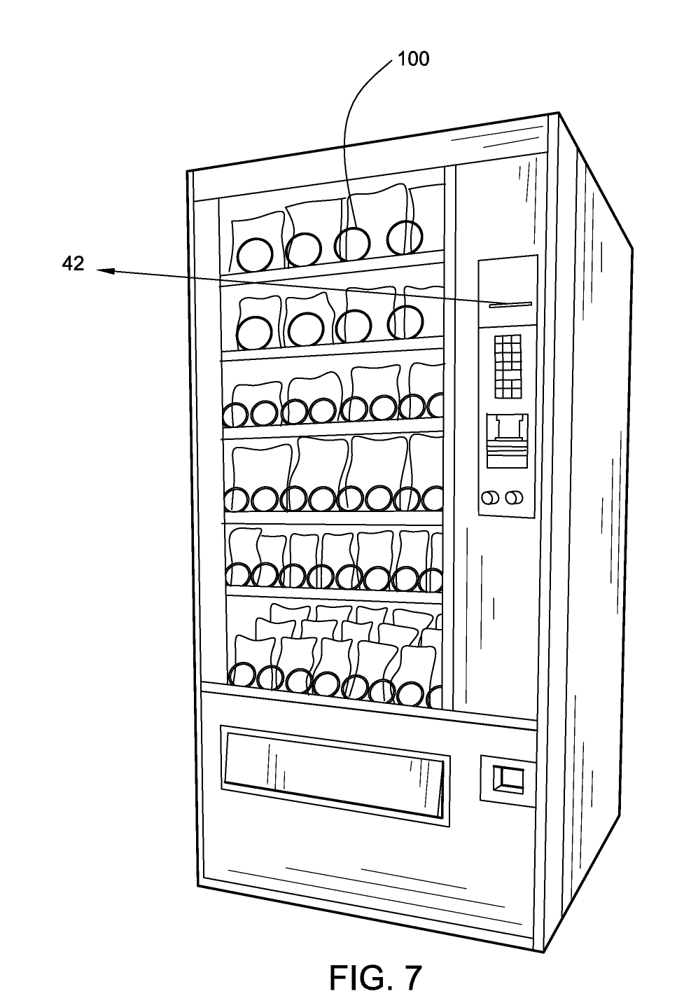

One exemplary embodiment for an implementation of a vending machine in accordance with the disclosure is shown in FIG. 2, and another in FIG. 3. In reference to these figures, a machine 16 is shown. The machine 16 includes a coupon dispensing module 14, disposed on the face 15 of the vending machine. In certain machine types, the face 15 may be transparent to display a plurality of items disposed therein for sale, or may alternatively contain graphics that portray the products such as snack, food and beverage (SFB) consumer vending machines, ice cream, made on-demand products, electronics, lottery tickets and the like. In one example, the items for sale may be loaded within pairs of metal spirals 100 (FIG. 7) that are disposed within the vending machine, and which rest upon adjustable shelves. In this embodiment, each pair of spirals is connected to one or more gear(s) (not shown), which is/are connected to one or more electrical motor(s) (not shown). The electrical motor(s) is operated selectively in response to a command from a controller to dispense a product when a sale is completed.

The vending machine 16 may further include a keypad 38 or another input device through which a user may make a selection for the product desired to be purchased from the machine. In the illustrated embodiments, the vending machine may include an advertising board 12 (FIG. 2), disposed proximate to the top of the face 15, for displaying advertisements. Although the advertising board 12 is shown towards the top of the face 15, other locations may be used.

To select an item, a purchaser inputs appropriate information to designate a button or combination of buttons that correspond to the dispensing of a particular item. Such information is captured by a microprocessor 20 and related circuitry (shown in FIG. 3), which is disposed within or otherwise associated with the machine 16. The microprocessor 20 is configured to operate in accordance with computer-executable instructions operating to monitor and control various functions of the vending machine 16. For example, the machine 16 may include a validator mechanism 13 configured to accept payment for the products sold, the payment being in the form of cash, credit, or coupon payment, report to the microprocessor 20 that sufficient value for a product selection has been received, and/or that the particular product that was paid for can be dispensed. The vending machine may optionally include sensing mechanisms to verify that an item is actually dispensed.

As best shown in FIG. 3, the microprocessor 20 may be associated with additional hardware and software to effect the distribution of coupons in accordance with the disclosure. In the illustrated embodiment, the microprocessor 20 includes a trafficking software 21 module, which is encoded on non-transitory computer-readable media, and a communication module 19, which allows the microprocessor 20 to communicate with the media center 5 (also shown in FIG. 1). The microprocessor 20 may further be associated with and control the operation of hardware devices such as a paper dispenser and coupon printer mechanism 22, which stores paper, dispenses paper for printing of coupons, prints coupons in accordance with commands provided from the microprocessor, and a coupon dispensing module 23, which dispenses the printed coupon to the consumer when a sale is complete and the product is about to be or has already been dispensed from the machine 16. Alternatively, or additionally, coupons may be distributed via non-printable media, such as by creation of visual representations on a screen associated with the vending machine that can be read or otherwise sensed by the consumer, for example, in the form of a barcode or visual scanning code that is readable by a smartphone or another mobile computing device.

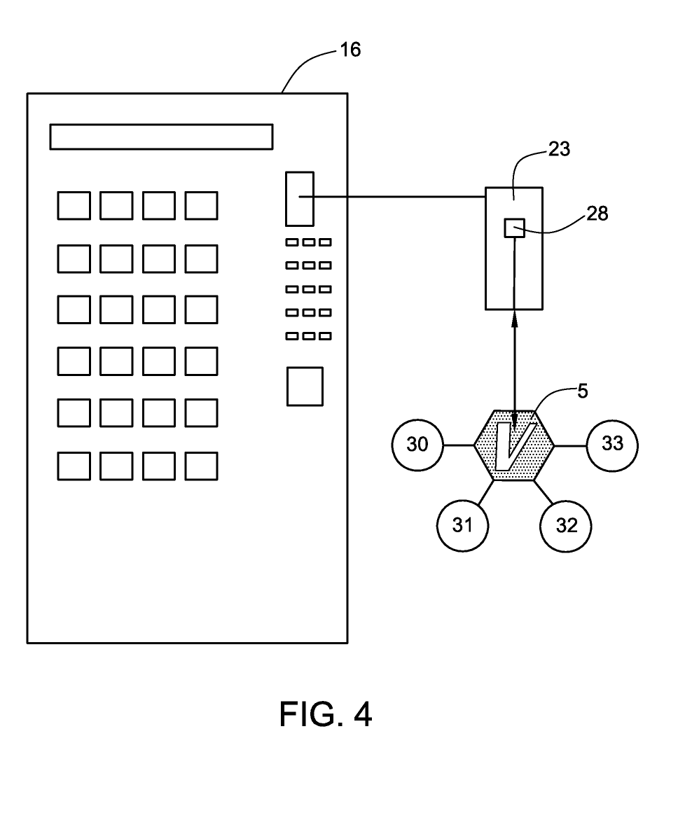

FIG. 4 is an electrical block diagram representation of the vending machine 16, having a coupon dispensing module 23 associated therewith. In this embodiment, the coupon dispensing module 23 includes computer-executable instructions implemented to function as a couponing trafficking software 28 module, which is communicatively connected to the media center 5 and configured to exchange information therewith. In this embodiment, the media center 5 can send information to the couponing trafficking software 28 relative to which coupons to dispense for the respective products sold by the machine 16. Such information may be generated by the media center 5, or may be relayed thereby from other controls operating to monitor and manage advertising campaigns in designated areas or regions such as local 30, regional 31, national 32 and international 33 levels. In an alternative embodiment, the control electronics of the vending machine may be suitably modified to perform substantially all of the communication and control functions of the coupon dispensing mechanism. In this regard, the coupon dispensing module may be made as a separate plug-in module such that it is retrofit into existing vending machines. The coupon distribution module may also be implemented as an integral part of the vending machine such that control and communication with respect thereto is performed by the vending machine itself.

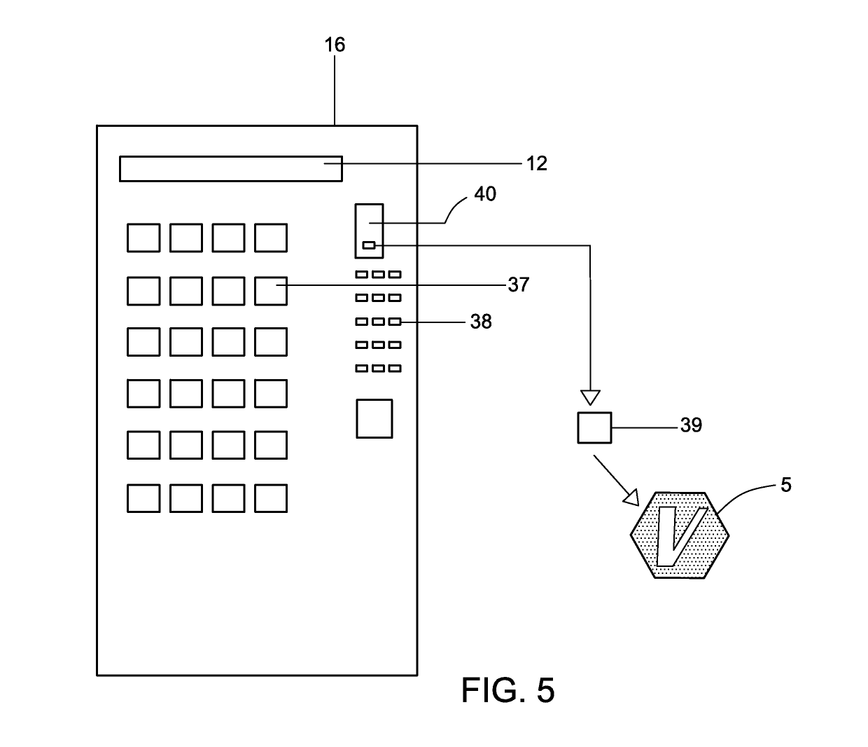

FIG. 5 is another block diagram representation of the vending machine 16, illustrating various features of operation by the coupon distribution module according to one embodiment of the disclosure. When a consumer chooses a product 37 via a keypad 38, the machine triggers a release of the product. Simultaneously, the purchase triggers a coupon through the purchasing data software 39, which is stored in non-transitory, computer-readable and executable media, and which sends a signal to the media center 5 to release the selected advertisement and coupon or coupons in the proper geographic territory. In one embodiment, advertising and coupon trafficking software 40, which may receive information from the media center 5, may be locally present in the vending machine or reside remotely to the machine and communicate therewith via a communication network. The advertising and coupon trafficking software 40 may communicate directly with the media center 5.

Implementation of a marketing or advertising campaign may optionally include usage of the advertising board 12, when one is present on the machine 16. For example, an advertising campaign may be enhanced through the advertising board, which announces particular offerings to attract purchasers to purchase one or more products based upon the coupon offering announced by the board. As explained in greater detail below, advertising campaign software and recovery of geographic and demographic data relating to particular vending machines are advantageously used to manage the advertising campaigns, as well as messaging thereof on the board, which in the illustrated embodiment may be implemented as an electronic display of any known variety.

FIG. 5 also illustrates one suitable interface to the media center 5 that may be implemented as a web server that hosts a secure website comprising one or more interrelated web page files and other files and programs. The files and programs are accessed via the network such as the Internet, by sending a hypertext transfer protocol (HTTP) request specifying a uniform resource locator (URL) that identifies the location of one of the relevant web page files, wherein the files and programs are owned, managed or authorized by a single entity. Such files and programs can include, for example, hypertext markup language (HTML) files, common gateway interface (CGI) files, and access to other resources.

Accordingly, the media center 5 may be used as a central repository for relevant advertising, coupon, and product purchasing data. Because the media center 5 creates, deploys, manages and receives data from the various dispensing modules, the system has the capability to synchronize advertising campaigns with data relating to consumer demand and purchasing habits.

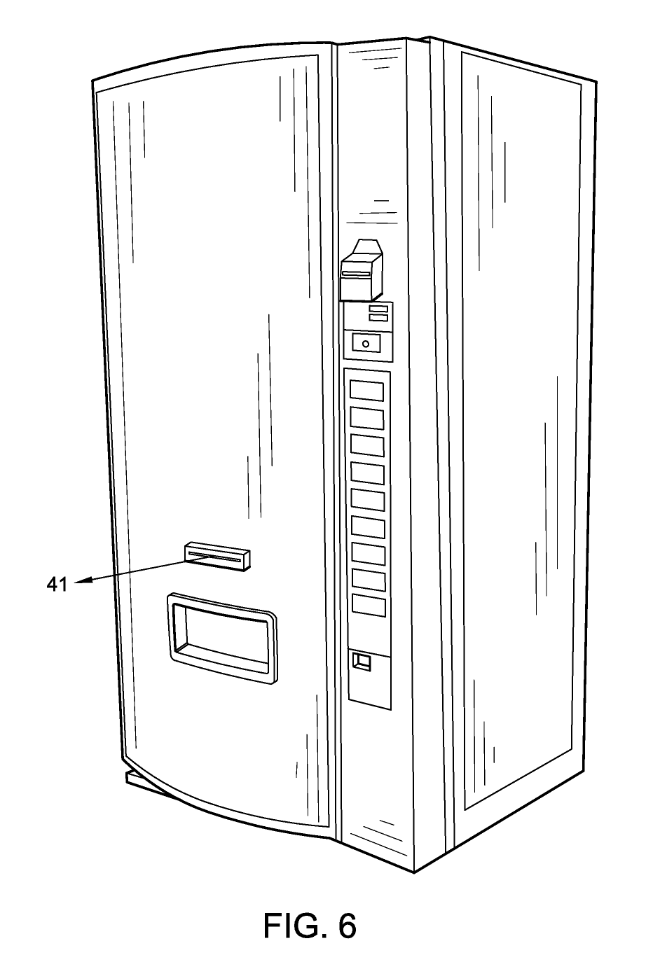

FIGS. 6 and 7 are diagrammatic illustrations showing two possible installations of a coupon dispenser on the face of a beverage vending machine 41 (FIG. 6) and a shack food vending machine 42.

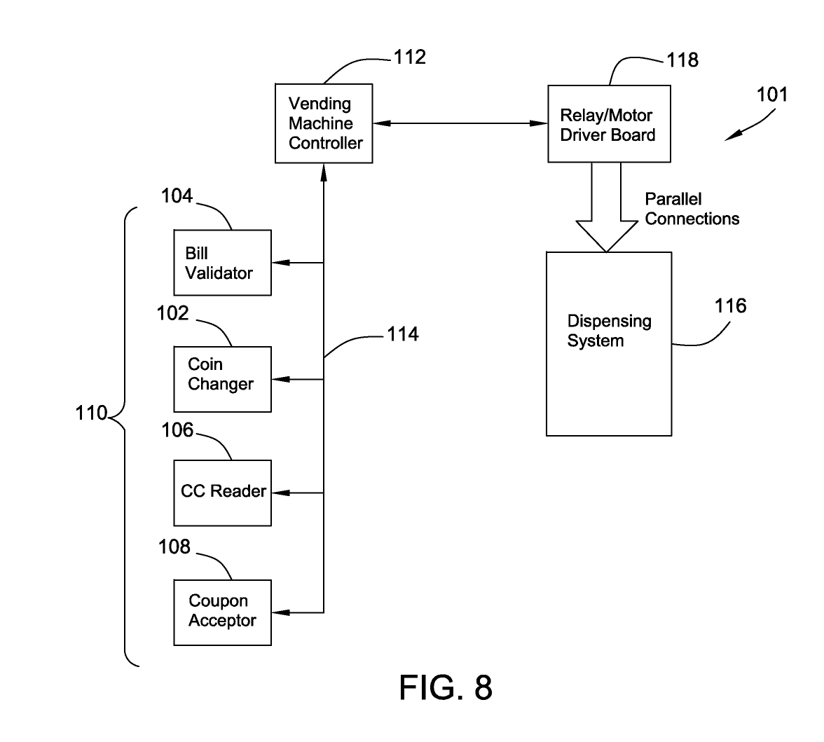

A block diagram for a system 101 operating to dispense coupons from a vending machine is shown in FIG. 8. The system 101 may be integrated with and operating within a vending machine 16, as shown and described above. The system 101 of the illustrated embodiment includes a coin changer 102, bill validator 104, an optional credit card reader 106, an optional coupon acceptor 108 and/or other payment or credit accepting devices. These and/or other payment and/or credit accepting devices are collectively indicated as payment entry devices 110. The payment entry devices 110 are connected to a vending machine controller 112 via an appropriate bus 114. The vending machine controller 112 may be a single controller or may include more than one controller disposed to control various functions and/or features of a machine. For example, a master controller, used to control the overall operation and function of the machine, may be cooperatively implemented with a motor controller, used to control the product dispensing system 116 of the machine. In this embodiment, the term “controller” is meant to include one, two, or more controllers that may be associated with the system 101 and that may cooperate in controlling various functions and operations of the machine 16 (FIG. 2). The functionality of the controller, while shown conceptually in the figures that follow to include various discrete functions for illustrative purposes only, may be implemented in hardware and/or software without regard to the discrete functionality shown. Accordingly, various interfaces of the controller are described relative to components of the vending system shown in the block diagram of FIG. 8. Such interfaces are not intended to limit the type and number of components that are connected, nor the number of controllers that are described.

The vending machine controller 112 communicates commands and, in some embodiments, also receives feedback signals, with respect to a relay/motor driver board 118. The relay/motor driver board 118 is an interface device translating command signals from the vending machine controller 112 into electrical signals for driving electrical components such as relays, solenoids, motors, belts and the like within the product dispensing system 116 for dispensing product from the machine. While the system 101 may be build-in or integrated with a machine, certain embodiments are configured to be added onto existing machines. Certain aspects of either the built-in or add-on systems are similar in the way the controller communicates with the media center and in the way coupons are dispensed.

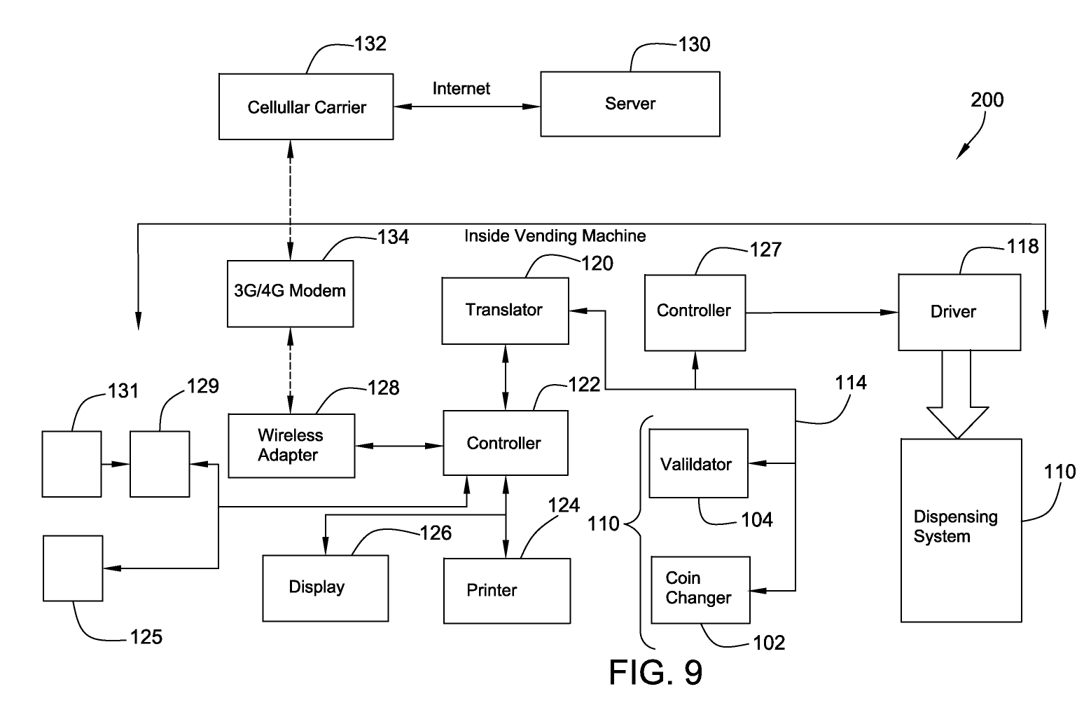

An alternative embodiment for a system 200 is shown in FIG. 9. In this embodiment, an add-on system configuration is shown. Elements and functions that are the same or similar to corresponding elements and functions previously described are denoted with the same reference numerals as previously used for simplicity. In the system 200, the bus 114 is further connected to a translator 120, which converts payment information provided by the payment entry devices 110 to a marketing system controller 122, which in the illustrated embodiment is a stand-alone controller configured to be added-on to an existing machine or to a new machine.

The marketing system controller 122 is connected or otherwise associated with various systems for carrying out the selection, printing and dispensing, or provision of coupons, for example, via an electronic display. Specifically, in one embodiment, the marketing system controller 122 is connected with a coupon printer 124 and/or a coupon display device 126. The coupon display device 126 may be an electronic display that displays an electronic form of a coupon, for example, via a barcode, for reading and storage or redemption by a mobile computing device such as the consumer's smartphone. The coupon printer 124 may be any appropriate type of printing device configured to imprint onto paper or another media monochromatic, polychromatic and/or other types of markings, in response to signals and information provided by the marketing system controller 122. The coupon printer 124 in one embodiment is configured to retract paper coupons not retrieved by the consumer for destruction within the machine. An advertizing display 125, an example of which is the advertising board 12 (FIG. 5), can be any device that presents a visual representation of information such as advertizing for products, and/or announcements relative to the coupons available in the vending machine and other information, in response to signals provided by the marketing system controller 122.

The marketing system controller 122 is further connected to a wireless adapter device 128, which is configured to send and receive information between the marketing system controller 122 and a remote host or server 130. In the embodiment shown in FIG. 9, the server 130 can be a central control computer, such as the media center 5 (FIG. 2), in which information resides relative to the appropriate coupons that should be dispensed, their association with the products in the machine, and other parameters. This information is provided to the marketing system controller 122, which then carries out the creation and dispensing of the coupons at appropriate times. As shown, the server 130 communicates via the internet with a cellular carrier infrastructure 132, which in turn communicates with a modulation/demodulation (modem) device 134 that is connected or otherwise associated with the wireless adapter device 128, for example, via a local wireless signal (WiFi).

The marketing system controller 122 may be further connected to a demographics analyzer module 129, which may include a camera 131 or other visual information acquisition device. In one embodiment, the camera 131 may be associated with the vending machine and be disposed to have a viewing angle that includes the customer using the vending machine during a transaction. The camera 131 may acquire visual information relative to the customer, which is provided to the demographics analyzer module 129. The demographics analyzer module 129 may be physically located within the vending machine, as shown in the illustrated embodiment, or may alternatively be located remotely. The demographics analyzer module 129 may not store the visual information provided by the camera 131, and may instead analyze the information to classify the probability that each consumer falls within a specific demographic category such as gender and age categories. Such demographic information may also be correlated to the particular product SKUs that each customer purchased. Demographic information and the corresponding product information may be stored at the demographics analyzer module 129 or at the marketing system controller 122, and may be provided back to the media center 5 via periodic updates. The demographics analyzer module 129 may analyze the information provided by the camera 131 using any appropriate software and/or hardware such as the Intel® AIM Suite and/or other similar solutions.

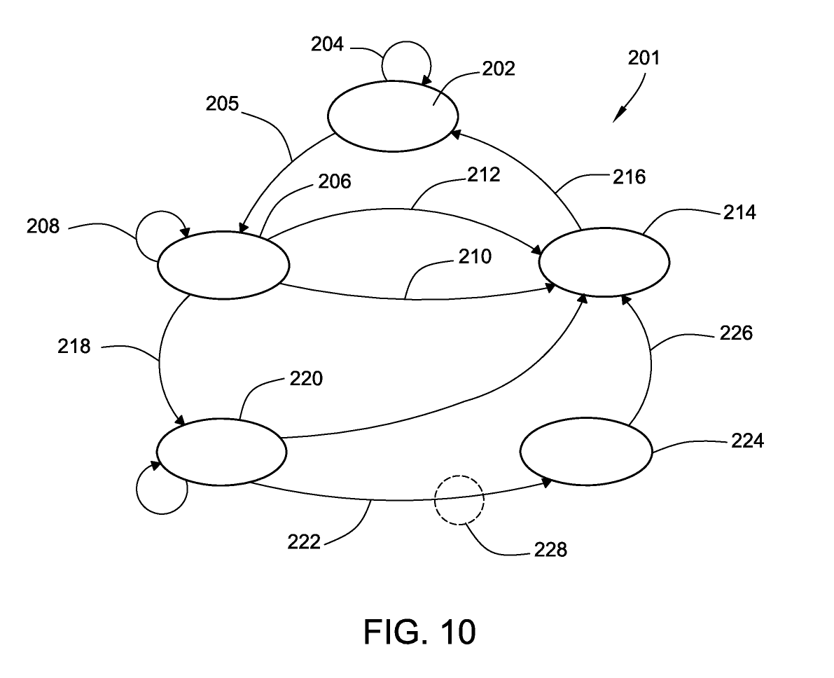

A state-flow diagram 201 for one embodiment of operation for a vending machine in accordance with the disclosure is shown in FIG. 10. At an idle state 202, the vending machine system awaits a customer. During this time, advertisements may be presented via an electronic display of the machine at a process 204, and/or the machine may query the media center on a periodic basis for updates to a marketing program. When a coin or other payment is inserted at 205, for example, a paper bill, credit card, or coupon, the system evaluates the value inserted at 206 and awaits a full value for a product that will be sold to be inserted at 208. If the operation is cancelled by the customer at 210, or insufficient value is present for a predetermined period at 212, any value inserted is returned to the customer at 214 and the system returns to the idle condition at 216.

When the value determination at 206 indicates that sufficient and valid value has been deposited in the machine at 218, the system awaits for the customer's selection at 220. In the event the selection is cancelled by the customer, the system returns the value at 214 as previously described. When a selection is made at 222, the product is dispensed at 224, and residual value (change) is calculated at 226 and returned at 214 as previously described. In the illustrated embodiment, the selection at 222 indicates to a marketing system controller that a valid sale has been made at 228. This indication at 228 prompts or activates a separate process for selecting, presenting and/or dispensing an appropriate coupon relative to the product selected at 220.

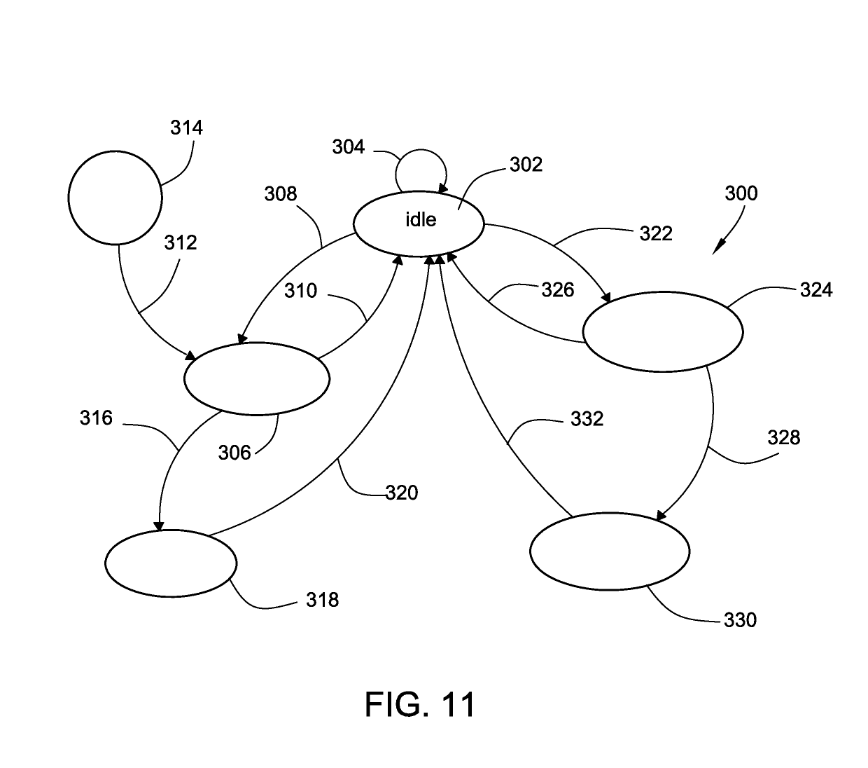

A state-flow diagram for dispensing an appropriate coupon, which corresponds to the product selected for sale at 220 in FIG. 10, is shown in FIG. 11. In reference to this figure, a coupon dispensing system 300 is shown. The system 300 remains at an idle state 302, during which time the system may query at 304 the vending machine system 201 (FIG. 10) for the consummation of a transaction with a customer, as previously described. At predetermined time intervals as indicated, for example, by a looping timer, the system may communicate with a media center at step 306 for updates when a predetermined time has elapsed at 308. When no updates are present at 310, the system may return to the idle state at 302. In the illustrated embodiment, the system 300 may also check for updates at 312 at initial system startup at 314. When the update query to the media center at 306 indicates that an update exists for the coupon database at 316, the new set of coupons are fetched or, stated differently, downloaded to a database residing in an electronic controller associated with the vending machine at 318, and the system returns to the idle state 302 at 320.

While at the idle state 320, apart from the update queries, the system 300 awaits for the consummation of a vend or other transaction from the vending machine as previously described. When a transaction is consummated, for example, by selection of a product by a customer after sufficient value has been inserted in the machine, as previously described, the system acknowledges the sale at 322 and interrogates the resident database at 324 to determine whether a coupon is available that corresponds to the particular product sold. When no corresponding coupon is present at 326, the system resumes the idle state at 302. When one or more corresponding coupons are present and a match is/are identified at 328, the matching coupon is printed and dispensed at 330, and the system returns to the idle state 302 via a default return process 332. Alternatively, the machine may have predetermined associations between products and coupons such that a coupon can be presented based on the identification of the product being dispensed alone, i.e., without querying a database. When returning to the idle state, the system may perform other operations such as recording in non-transient memory a record of the transaction, or performing house-keeping operations, for example, to determine whether sufficient printing supplies remain or require replenishment. Such and other machine information may be communicated back to the media center, for example, with each periodic query for updates as described relative to query step 306 above, or as a separate reporting operation. When communicating with the media center, the system may further provide identifying information for the particular machine including machine serial number, geographical positioning, maintenance information, and other information not directly related to the sale of the products.

While the embodiments have been described herein with respect to vending machines and apparatus, there are additional strategic marketing programs that may be developed, for example, ATM's, Video Movie Machines, Entertainment, Sports and Movie Venues, Amusement Parks and the like. In addition, customized niche campaigns may be used for professional or amateur sporting events and the like, such as the NFL, NBA, NHL, MLB, MLS, Olympic Games, Other Professional and Minor League Organizations. Similarly, the disclosure may be used in conjunction with School Districts, Scouts, Entertainment, Amusement and Golf Parks, Venues, and other Properties.

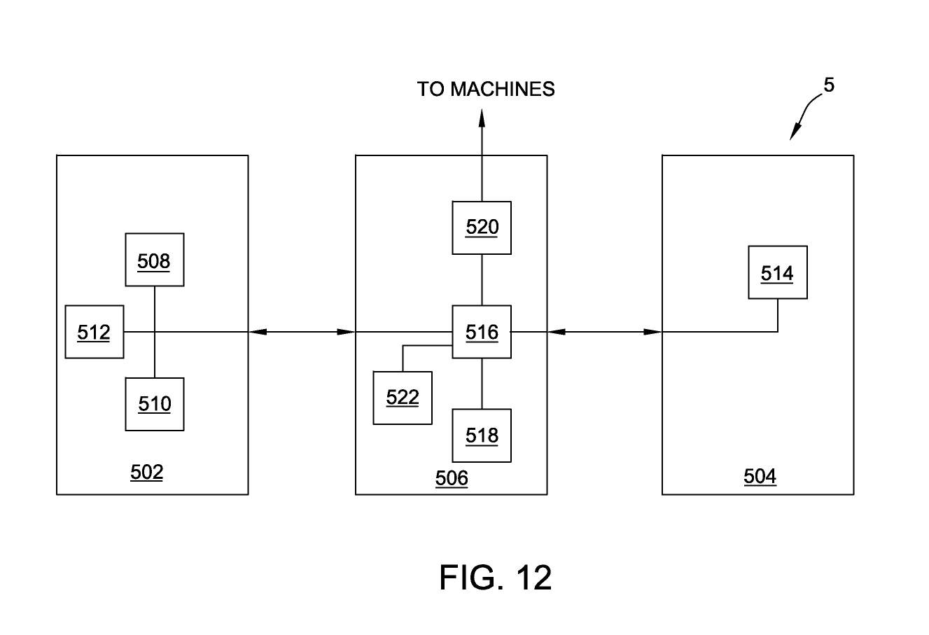

A block diagram of one embodiment for the media center 5 is shown in FIG. 12. In the illustrated embodiment, the media center 5 includes various modules that are communicatively connected and perform various dedicated functions. In one implementation, the media center 5 can be a web-based application designed to send and receive information from various vending machines in a network. In this way, the media center 5 can be configured to send instructions to each vending machine, periodically or as required, on which coupons to print when a product is dispensed from a particular vending machine. The media center 5 can also receive product vend statistics, customer demographic information, and other information about the vending machine and displays them for review. From a general perspective, the media center 5 includes three sub-modules. The illustrated sub-modules include a machine section 502, which includes information or otherwise describes each physical vending machine in the network, an ads section 504, which includes definitions for or otherwise describes the various coupons or advertisements that can be dispensed, and a campaign section 506, which includes definitions or otherwise associates machines from the machines section 502 with ads or coupons form the ads section 504 on the basis of predetermined rules. Each of these sections will now be discussed in more detail.

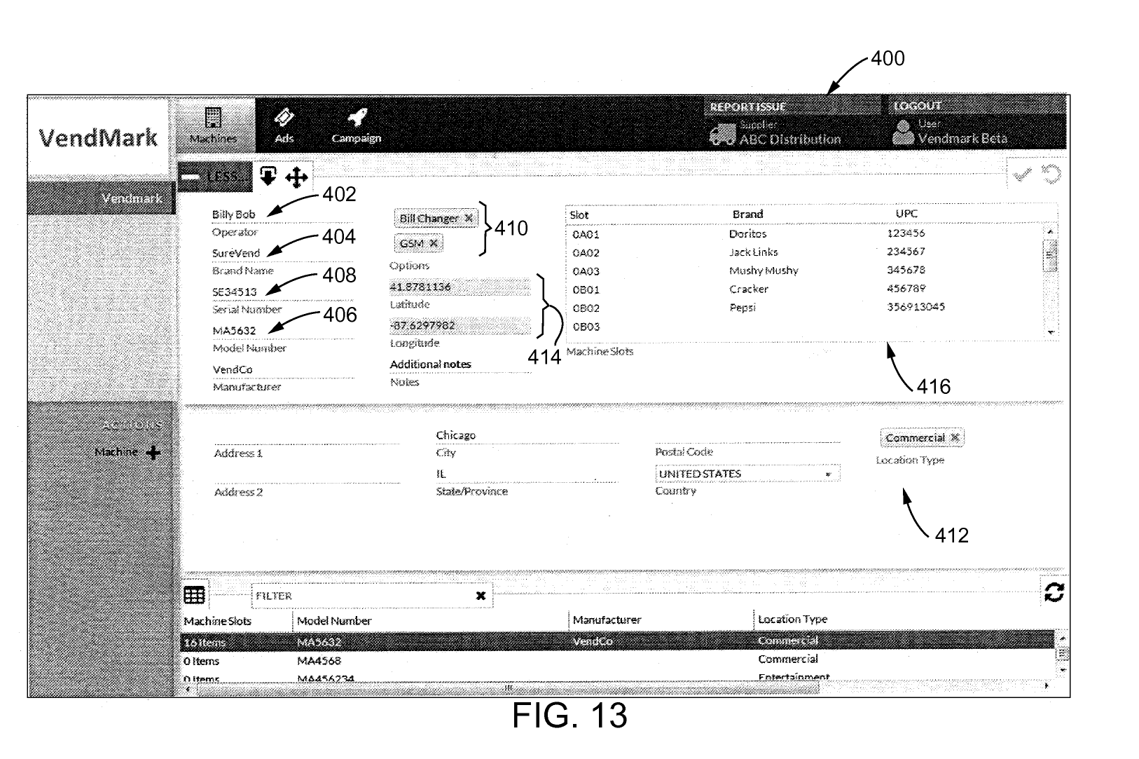

The machines section 502 includes a listing and information about each of the machines in a network. A sample application user interface 400 for the machines section 502 is shown in FIG. 13. In reference to FIGS. 12 and 13, the machines section 502 includes various parameters such as the machine owner 402, machine brand 404, model 406 and serial number 408, the equipment present on the machine 410, the physical address at which the machine is installed 412, the geographical (GPS) location of the machine 414, and other information. In the media center software application, machine serial number may be used to identify and track each machine according to its physical location. This information may be stored in a machine database 508 and be available for retrieval or access by the ads section 504. The machines section 502 may further include a products database 510, which includes identifying information on the number of product slots available on each machine 416, which includes information relative to a particular address, location or other identifier for each product slot, the product residing in each slot, the SKU number for such products, the manufacturer of each product, and other product information. All this information is generally shown within the field denoted as 416 in FIG. 13. The products database 510, like the machine database 508, may also be accessible and the information found therein otherwise available to the ads section 504.

The machine section 502 may also include a machines modifier function 512. The machines modifier function 512 may be embodied as a dialog interface within a media center 5 software application that contains and allows editing of sub-set of the data stored in the machine database 508 and the products database 510. The machines modifier function 512 may be directly accessible from a user interface for editing of the information stored in the machine section 502. The information in the machine section 502 may then be manually or automatically accessed by the media center 5.

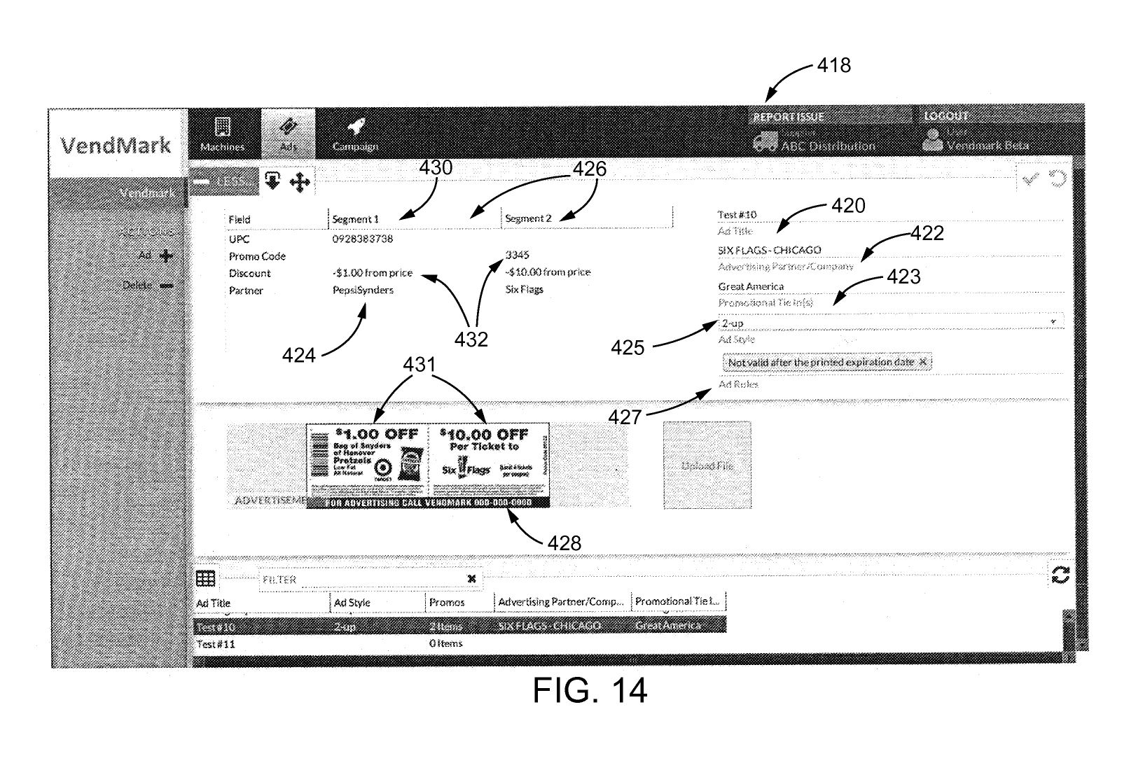

The ads section 504 includes information on the particular advertisements or other advertising campaigns that are disseminated to the machines by the media center 5. A sample user interface 418 for an application running at the media center for accessing and modifying information in the ads section 504 is shown in FIG. 14. In reference to FIGS. 12 and 14, the ads section 504 includes an advertising campaign information database 514 that is accessible by the campaign section 506. The advertising campaign information database 514 includes fields populated with information relative to the particular products, manufacturers and advertising campaigns that are available to the media center 5. Specifically, the advertising campaign information database 514 includes information that identifies a particular advertisement by name or designation 420, for purpose of identification, the company involved with selling the marketing printed on the coupons 422, the actual product that is the subject of the advertisement 424, the high-level configuration(s) of the advertisement 426, the actual image to be printed on the coupons for each advertisement 428, the UPC code of the product being covered 430, a formula describing each offer 432, a retail partner sponsoring the offer, and/or other information that is applicable to each advertising campaign such as the geographical region that is relevant or intended for each advertising campaign. In the illustrated embodiment, the coupon includes two segments 431, each of which can be tailored to present different coupons. Although two segments are described and shown, a single segment or more than two segments can be used. A selection field 425 for the desired number of segments can be used to define the various areas on the coupon.

Alternatively, entries may be duplicated if applicable to more than one geographical area, advertising campaign code, discount, or retail partner. The information in the advertising campaign information database 514 may be accessed on-demand as needed, and may also be updated either manually or automatically as required. In the embodiment shown, a field 427 for establishing rules can be used. Rules, in this function, can be established to dictate certain parameters for each ad, for example, effective and expiration dates, applicability only to machines in certain venues but not others, and others. This capability enables the venue-specific use of advertising campaigns with great flexibility.

The ads user interface 418 further includes a field 423 for so-called advertising campaign tie in(s). In one embodiment, advertising campaign tie ins include additional coupons, advertisements and/or other information that can be pre-printed onto the back side of the paper used to print coupons, as described above. The field 423, therefore, can identify the particular tie ins that can be used on each machine. For example, where the front of the coupon may be printed in accordance with a national advertising campaign, the tie ins on the back side of the coupon can be tailored to a specific market, region, location, and so forth. The images used to populate each segment 431 of the coupon may be compiled by a user using pre-defined library items, graphics, and text, or may alternatively be pre-arranged and uploaded as an image file. Any such segment images may be maintained in a database and be accessible by particular authorized users for re-use in future campaigns.

When defining ad rules, the absence of a rule can be defined as the default rule, whereby a predetermined ad or other information may be printed, if desired. When ad rules connecting machine slots, i.e., products, to particular coupons, to avoid conflicts with possibly overlapping campaigns, a machine slot definition is configured to override a product SKU or UPC definition, which overrides a product brand definition. In this way, various ads can be defined for the same products by defining either the machine slot for a particular product, the SKU or UPC for that product, or the brand of the product, depending on whether the user is local, regional, national or international. By providing a hierarchy, the system avoids conflicting ads for the same products in the same markets.

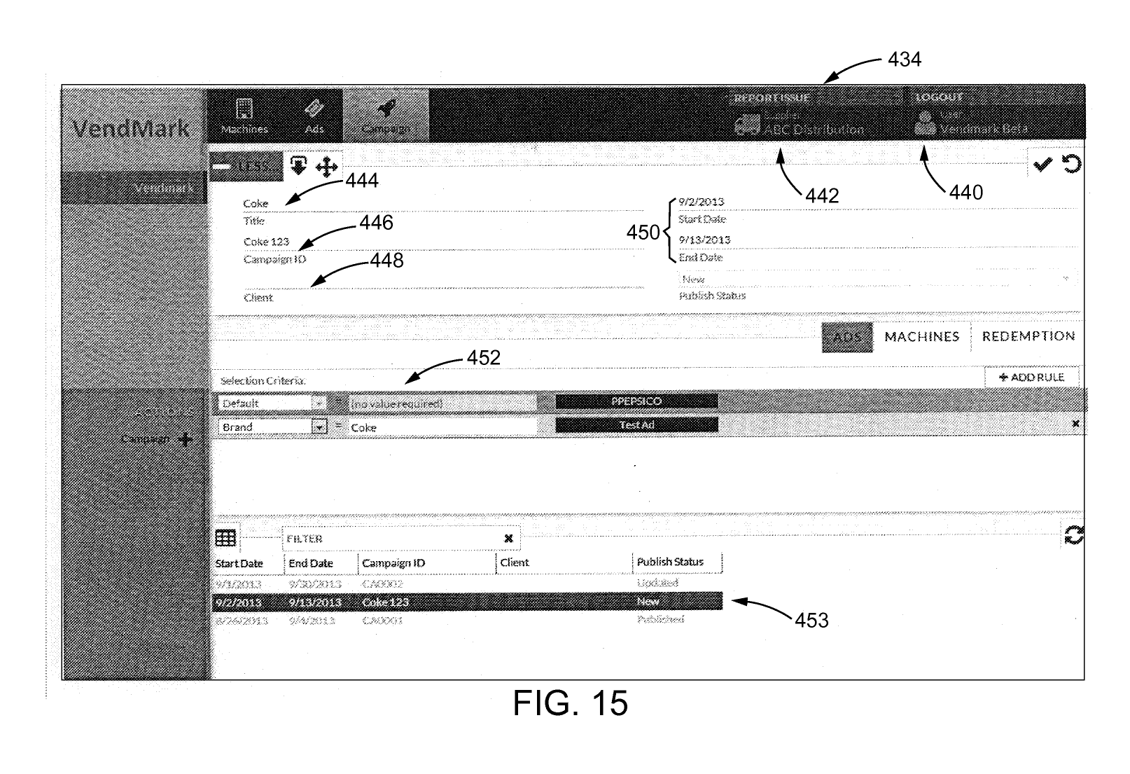

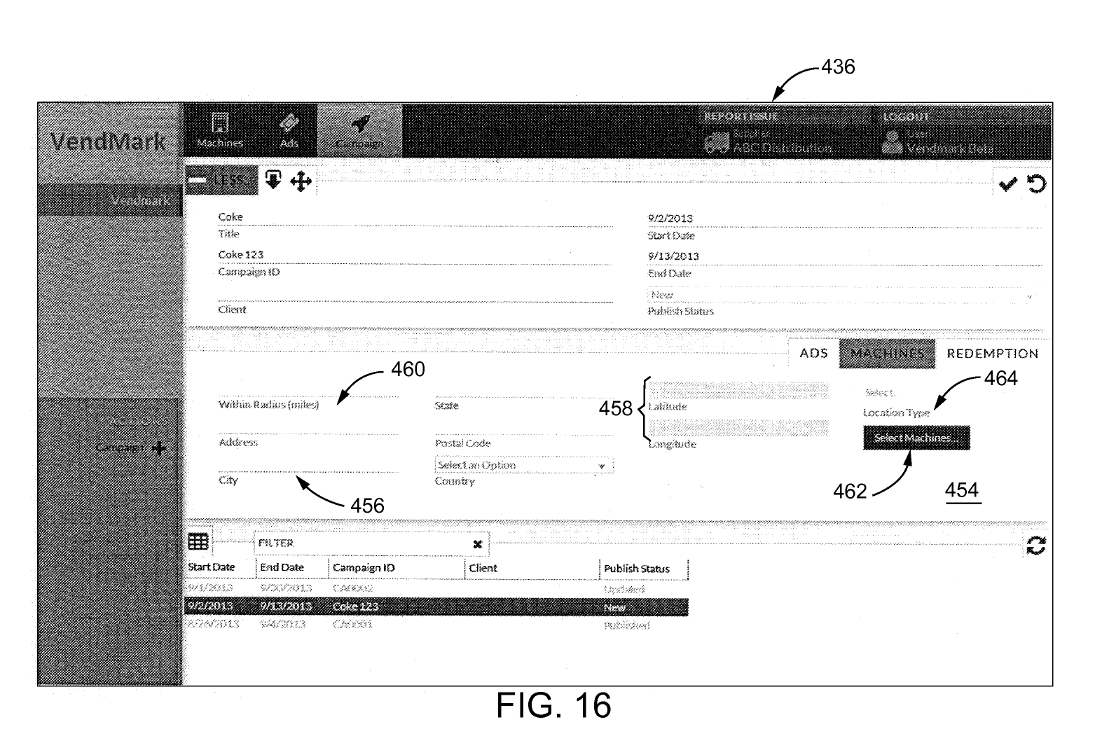

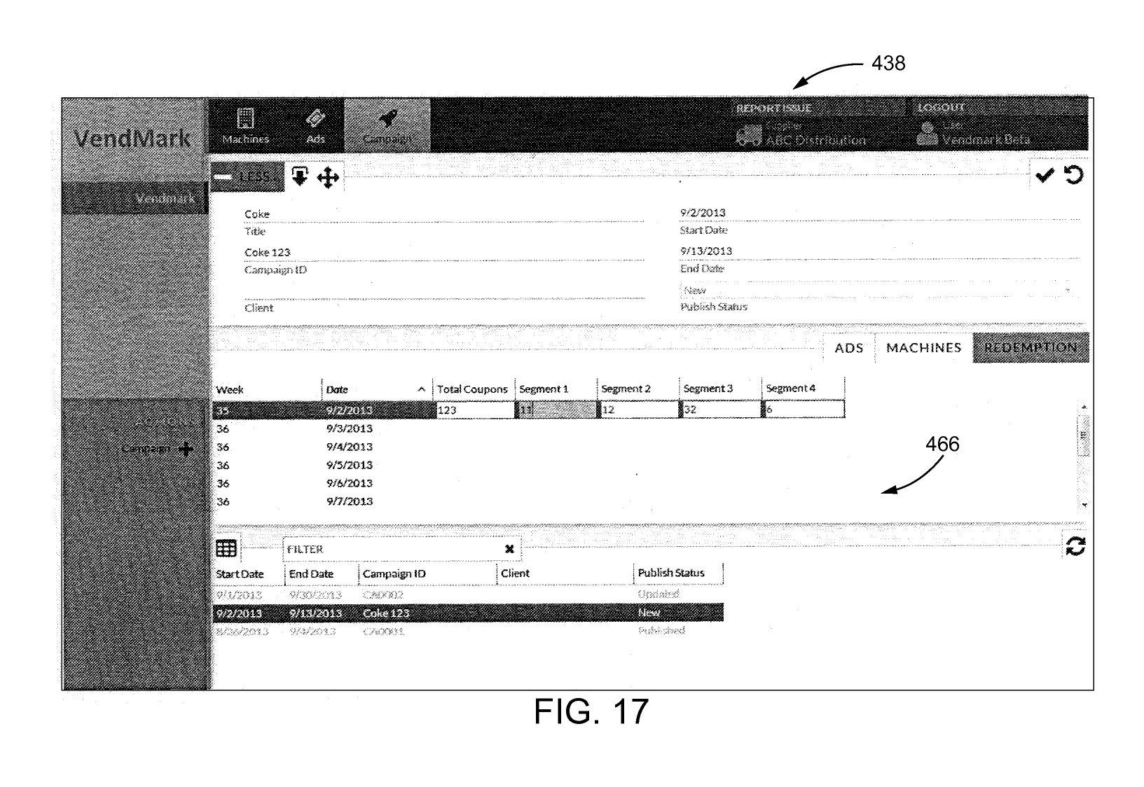

The campaign section 506 includes information relative to various campaigns, which, as used here, define the sets of rules governing which machines, and which products in those machines, may be encompassed in advertisements or advertising campaigns. Three sample user interfaces 434, 436 and 438 are shown in FIGS. 15, 16 and 17 respectively. In one aspect, the campaign section 506 combines, under specific rules, the particular machines, products in those machines, and specific advertising campaigns into packages of information, which are then disseminated to the machines affected. The particular user interface with respect to ads is shown in FIG. 15. The user interface with respect to machines is shown in FIG. 16, and the user interface with respect to redemption is shown in FIG. 17.

The campaign section 506, includes a rules module 516 that has direct access to the machine database 508, products database 510, and advertising campaign information database 514, as shown in FIG. 12. The rules module 516 also includes a set of rules, which are stored in a rules database 518. During operation, the rules module 516 retrieves a set of rules from the rules database 518, and then interrogates the databases 508, 510 and 514 to compile an appropriate package for each rule. The package is then set to a communications module 520, which sends the respective packages to the machines as previously discussed.

In reference to FIG. 15, a user 440 that belongs to a supplier or user group 442 can define a campaign by title 444, campaign ID 446, client 448, effective start and end dates and publish status 450. The user may also perform various actions or campaign operations such as publish, update, cancel and others, via an actions function 452, and access existing campaign status and other information via a campaign list 453.

The rules database 518 may include information relevant to each advertising campaign. Specifically, the rules database may include information that includes a short description of the campaign, an identifier for the campaign, the person or company the campaign is designed for, the starting and ending dates of the campaign, whether the campaign can be published, and other information.

The rules database 518 also includes information on which machines will be involved in each campaign. In one embodiment, address based fields are used to specify a Latitude/Longitude of the center of a circle. The radius field defines the size of the geographic circle. All vending machines within the circle can be attached to this campaign. Alternatively, individual machines may be attached or added to a rule as desired. In reference to FIG. 16, a machine identification area 454 enables the filtering or selection of machines, individually and as a group, by any number of parameters. For example, a user may define a physical location by it street address 456, by its coordinates 458, and may further encompass machines lying within a radius or distance 460 from a particular location. The user may alternatively or additionally add individual machines by using a specialized function 462, or define machines based on the type of location they are operating in such as sports arenas, malls, schools and the like, by using a function 464. Any combination of machine groups and individual machines can be compiled and attached to a particular campaign.

The system can also track redemptions of coupons presented. As shown in FIG. 17, a data field in tabular form 466 may be compiled with respect to the date, time, number of coupons, and segment of coupons that were redeemed by customers. Additional information, such as demographic information as previously discussed, may also be appended to the coupon redemptions.

In general, the campaign section is used to assign specific ads (coupons) when a product is dispensed from the vending machines. The ad to be printed can be defined using four rules. First, a default rule under which, if no other rules are defined, a default ad may be printed. Second, an ad is printed in the appropriate field if the brand of the ad matches the product brand name present in the products database 510 for a particular machine slot. This check is performed to ensure that errors are avoided. Third, as an additional check, the ad is printed if the UPC code of the product selected for the ad from the products database 510 matches the UPC code provided from the advertising campaign information database 514. Finally, the ad is printed if the respective machine slot identifier in the products database 510 matches the provided value. It is noted that the slot identifier is created by the machine controller present in the machine such that errors or changes in product placement during loading of the machine can be avoided.

The system is also configured to collect information from the machines during service. Accordingly, a redemption database is configured to receive information from the various machines in the field. Such information includes date and time information for sales, the date when a redemption was given, the number of coupons dispensed for a particular campaign, the dates on which the various coupon were redeemed, the number of coupons redeemed, the segments of the ad that were redeemed, and other useful redemption information. The redemption information can be used to then select the more successful campaigns, which selection can then be communicated to the clients or partners sponsoring the campaigns.

By using the media center 5 as shown here, a user may advantageously set or modify particular rules that can change the coupon design at particular machines in real time. Alternatively, the machines can dispense or otherwise present pre-printed coupons. Moreover, tailoring of the advertising campaigns can be accomplished almost in real time and with great flexibility for particular products, in particular regions, for particular clients very quickly and efficiently. An advertising campaign can be implemented for as little as a single product in a single machine, to any number of products in any number of machines swiftly and easily. Moreover, the collection of redemption information may be used to valuate each advertising campaign as well as provide information on the success of each advertising campaign. In one embodiment, redemption information can be used to modify current or future advertising campaigns, for example, by establishing rules that depend on particular redemption information.

In one embodiment, algorithms or other mathematical techniques may be embodied by the media center, for example, in the form of non-transitory, computer-executable instructions, to collect and analyze vend data, including customer data. Such functions may include, but not be limited to, performance of data collection and analysis, data preparation, data mining, consumer profiling (age, race, purchasing history, etc.), institutional decisions and other functions. For example, an institution may use such data as a factor in determining what actions or policies to apply to groups or individuals whose data match a relevant profile.

One advantage of performing such functions and analyses can be to provide to users of the media center application, as described herein, the capability to use such information to conduct so called “smart campaigns,” which is meant herein as including advertising campaigns that tailor coupons based on the demographic of the purchasing public. For example, the intelligence may imply to a beverage company that a particular group of machines in a particular location are heavily used by a particular demographic such that an advertising campaign targeted to that demographic can be most effectively applied. Alternatively, with the use of demographic sensing capabilities, the same machine can cater to different demographics purchasing the same product by presenting targeted coupons for each purchaser. In one contemplated embodiment, advertising campaigns using more than one coupon can be implemented. In such campaigns, one of a series of different coupons associated with the same product can be cycled through to the consumers, for example, to maintain consumer interest, especially in the case where users habitually use the same vending machine to purchase the same or similar products on a periodic basis.

The disclosure described herein will itself suggest to those skilled in the various arts various alternative embodiments and solutions to other tasks and adaptations for other applications. The following claims, therefore, are intended to cover all such solutions and adaptations of the disclosure and those changes and modifications that could be made to the embodiments of the disclosure herein without departing from the spirit and scope thereof.

1. A coupon dispensing module for use in conjunction with a vending machine that is operable to generate a vend signal when a purchaser selects a desired product, the dispensing module comprising:
a selection mechanism adapted to select a desired coupon that corresponds to the desired product;
a presentation mechanism for presenting the desired coupon upon the receipt of an actuating signal; and
a control circuit coupled to the vending machine, the control circuit operating to select the desired coupon, operate the presentation mechanism based on requirements of the desired coupon, and provide the actuating signal to the presentation mechanism.

2. The coupon dispensing module of claim 1, wherein the control circuit is a microcontroller configured to further generate the vend signal.

3. The coupon dispensing module of claim 1, further comprising a display device associated with the vending machine and operable in response to signals provided by the control circuit to display information dictated by the control circuit.

4. The coupon dispensing module of claim 1, wherein the selection mechanism includes a database populated by coupon definitions provided to the control circuit by a central control, said coupon definitions being updatable on a periodic basis by the central control.

5. The coupon dispensing module of claim 1, further comprising a vending machine controller associated with the control circuit and arranged to exchange information therewith, said vending machine controller providing the vend signal to the control circuit, said vend signal including information specific to the desired product.

6. A method for operating a vending machine, comprising:
monitoring a vending system of the machine to determine whether a sale has been made;
when a sale has been made to a customer, determining a particular product sold;
associating the particular product sold with a selected' coupon, said selected coupon being selected from a plurality of coupons;
presenting the selected coupon to the consumer, and
dispensing the selected coupon to the customer within a short period before or after the particular product sold is dispensed from the vending machine.

7. The method of claim 6, further comprising periodically interrogating a media center for updates to a coupon definition database, the coupon definition database containing the plurality of coupons.

8. The method of claim 6, further comprising generating a vend signal when a sale has been made to a customer, said vend signal containing information indicative of the sale having been made and identifying information relative to the desired product.

9. The method of claim 6, further comprising defining a particular corresponding relationship between at least some of a plurality of products available for sale at the vending machine and at least some of a plurality of coupons available.

10. The method of claim 9, wherein defining the particular corresponding relationship is based at least partially on geographical information descriptive of the area in which the vending machine is operating.

11. The method of claim 9, further comprising displaying advertizing information on a visual display associated with the vending machine, the advertizing information including information on the plurality of coupons.

12. A method for controlling and monitoring a plurality of vending machines associated with a communications network by use of a media center, comprising:
defining a plurality of correspondences between products and coupons with respect at least on a geographical area;
creating a coupon database containing the correspondences, and maintaining the coupon database in non-transient computer readable media;
transmitting the coupon database to at least one vending machine;
updating the coupon database at least periodically; and
sending the updated coupon database to the vending machine.

13. The method of claim 12, further comprising:
monitoring transaction activity at the vending machine, providing a report including information indicative of the sale activity from the vending machine to the media center; and
processing the report at the media center;
wherein updating the coupon database is at least partially further based on the report.

14. The method of claim 12, further comprising:
accessing the media center to modify the coupon database.

15. The method of claim 12, further comprising communicating coupon information form servers of clients to the media center, and compiling a list of coupons for use when defining the plurality of correspondences.

16. A media center application, comprising:
a machine section including information on each of a plurality of vending machines, for each vending machine, the machine section further including information on the particular products available for sale;
an advertising section including information on particular advertising campaigns corresponding to particular products; and
a campaign section including information on advertising campaigns tying specific products to one of the particular advertising campaigns;
wherein a media center program includes advertising campaign rules correlating each of the particular advertising campaigns to products found in particular vending machines.

17. The media center application of claim 16, wherein the advertising campaign rules are specified by a user of the application and operating to correlate specific machines or groups of machines, which are tracked in the machine section, with specific products for sale in those machines, with one or more particular advertising campaigns from the advertising section.

18. The media center application of claim 16, wherein the advertising campaigns can specify one or more machines based, at least in part, on a location of each of those machines from a predetermined location.

19. The media center application of claim 16, wherein each of the advertising campaigns can be defined based on a brand, serial number or machine slot in which a particular product is present in a machine.

20. The media center application of claim 16, wherein each advertising campaign can be defined by region, including local, regional, national or international regions, product affected, machine, duration, and advertising campaign.
